(19) United States
(12) Patent Application Publication
(10) Pub. No.: US 2018/0276553 A1
(43) Pub. Date: Sep. 27, 2018

(54) SYSTEM FOR QUERYING MODELS

(71) Applicant: CISCO TECHNOLOGY, INC., San Jose, CA (US)

(72) Inventors: Tej Redkar, San Ramon, CA (US); Tian Bu, Basking Ridge, NJ (US); Harish Doddala, San Jose, CA (US)

(21) Appl. No.: 15/465,679

(22) Filed: Mar. 22, 2017

(51) Int. Cl. G06N 7/00; G06N 99/00

(52) U.S. Cl. CPC G06N 7/005; G06N 99/005

(57) ABSTRACT

The disclosed technology relates to machine learning and statistical models. A system is configured to receive a user statement comprising a request for information and identify an intent type and one or more parameters based on the user statement. The system selects a model from the model registry based on the intent type and the one or more parameters, obtains a result based on invoking the selected model using the one or more parameters, and provides the result to the user.

### TECHNICAL FIELD

The subject matter of this disclosure relates in general to the field of machine learning, and more specifically to selecting a machine learning model for performing a task.

### BACKGROUND

Machine learning models and statistical models provide the ability to intelligently analyze, predict, cluster, and classify datasets leading to a measurable and often times actionable impact. The machine learning field is rapidly growing with multiple tools and products providing a wide range of capabilities.

There is a growing need to be able to easily query and use such models for specific tasks including, for example, prediction, correlation, or anomaly detection. Using a machine learning model typically involves invoking a model using a well-defined syntax such as programming languages or formal grammars or through product specific APIs, SDKs and Tools

### BRIEF DESCRIPTION OF THE FIGURES

In order to describe the manner in which the above-recited and other advantages and features of the disclosure can be obtained, a more particular description of the principles briefly described above will be rendered by reference to specific embodiments that are illustrated in the appended drawings. Understanding that these drawings depict only embodiments of the disclosure and are not therefore to be considered to be limiting of its scope, the principles herein are described and explained with additional specificity and detail through the use of the accompanying drawings in which:

FIG. 1 is a conceptual block diagram illustrating an example network environment 100, in accordance with various embodiments of the subject technology;

FIG. 2 is an illustration showing an example chat interface, in accordance with various embodiments of the subject technology;

FIG. 3 is a conceptual block diagram illustrating an example of a model management system, in accordance with various embodiments of the subject technology;

FIG. 4 shows an example process for obtaining a result from a model management system, in accordance with various embodiments of the subject technology;

FIG. 5 is a chart illustrating relationships between user statements, intent types, parameters, and models, in accordance with various aspects of the subject technology;

FIGS. 6A and 6B illustrate examples of systems in accordance with some embodiments.

### DESCRIPTION OF EXAMPLE EMBODIMENTS

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

Although machine learning and statistical modeling is increasing in popularity, using such techniques is not very intuitive for most people. For example, most machine learning models are invoked using a well-defined syntax or formal grammar that requires training for users to use properly. Furthermore, even if a person is able to invoke the models, most people do not have a good enough understanding of the underlying technology to know which models, machine learning or otherwise, are suitable for which tasks.

Machine learning technologies are so esoteric that many organizations hire specialized individuals (e.g., data scientists) whose responsibility is to aid others in the use of these technologies. For example, in the information technology (IT) realm, administrators may be responsible for managing, maintaining, and monitoring applications, networks, or other equipment. Machine learning models may be very useful in identifying potential threats, predicting resource use, identifying trends and anomalies, and delivering countless other insights. However, because of the difficulty in using machine learning models, many administrators do not leverage the technologies or must contact a operators with specialized machine learning knowledge and describe their situation and goals to them. The specialized operators must then leverage the machine learning technologies based on their conversation with the administrators. This is a time consuming process fraught with pitfalls, misunderstandings, and errors since the administrators are unfamiliar with machine learning technologies and the specialized operators are unfamiliar with the IT landscape.

Various embodiments of the subject technology address these and other technical problems by providing a system with a natural language interface for users to request information. The system may receive the request and derive a user intent and one or more parameters, select an appropriate model from a model registry, and invoke the selected model in order to obtain a result that may be provided to the user.

### DETAILED DESCRIPTION

Various embodiments of the disclosure are discussed in detail below. While specific implementations are discussed, it should be understood that this is done for illustrative purposes only. A person skilled in the relevant art will recognize that other components and configurations may be used without departing from the spirit and scope of the disclosure.

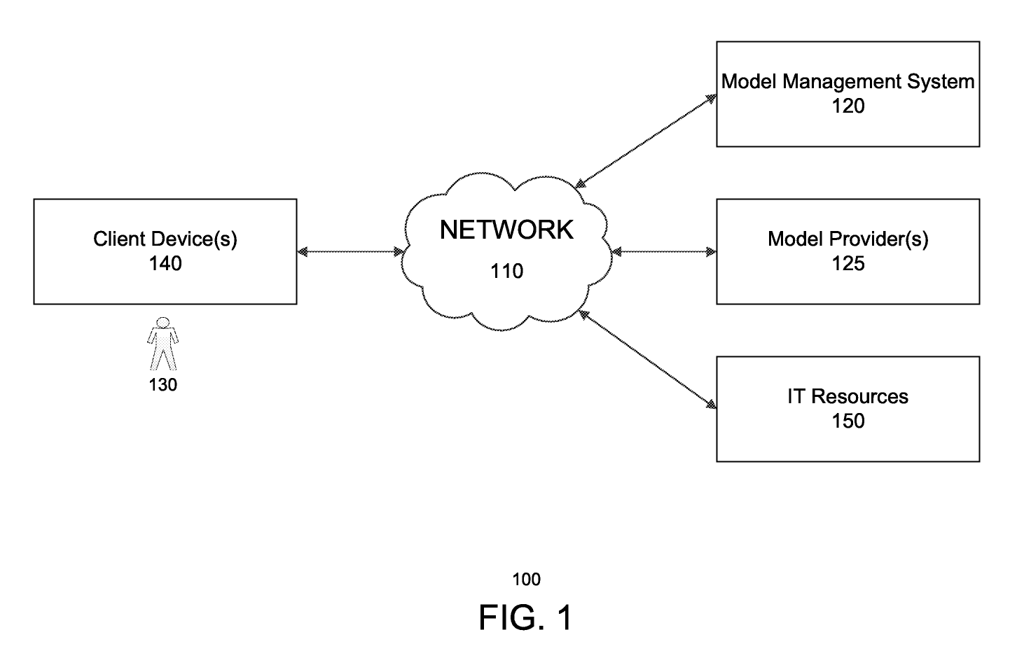

Various embodiments relate to a system that automatically determines a machine learning or statistical model to use based on a natural language query from a user. The system may further be able to execute a selected model and report results back to the user. FIG. 1 is a conceptual block diagram illustrating an example network environment 100, in accordance with various embodiments of the subject technology. Although FIG. 1 illustrates a client-server network environment 100, other embodiments of the subject technology may include other configurations including, for example, peer-to-peer environments or single-system environments.

The network environment 100 includes a model management system 120 that is in communication with one or more client devices 140 via a network 110. The model management system 120 may be configured to communicate with a user 130 via a client device 140 associated with the user 130. The model management system 120 may receive user statements that include requests for information via one or more communications channels. The communications channels may include, for example, voice calls or messages, video calls or messages, text messages, or instant messages. The communication channels may be provided by the model management system 120 or by another third-party communications provider (e.g., a third-party application).

The user statements, in some embodiments, may be natural language statements that the model management system 120 may use a natural language processor to extract information from. The model management system 120 may extract, for example, an intent type that represents the function to be performed to satisfy the user statement, one or parameters for the type of information requested, and/or a set of data on which to operate.

The model management system 120 may search a registry of available models based on the extracted information and select one or more models that may be used. The available models may include various machine learning models or statistical models such as linear regression, time series, clustering, or logistic regression models. In some embodiments, these models may be scored by the model management system 120 in order to identify an appropriate model to use. Once an appropriate model is identified, the model management system 120 may map the extracted information to the appropriate inputs to be provided to the model and invoke the model.

Invoking the model may include using an application programming interface (API) to call a model provided by one or more model providers 125. In some embodiments, the third-party model providers 125 may provide such services as a part of a larger offering of cloud services. One or more of the model providers 125 may also be associated with or a part of the model management system 120 and the models supported may be invoked using a defined syntax. The model providers 125 may support one or more models including machine learning models, statistical models, or a combination of models.

After the invoked model completes processing, a result is returned to the model management system 120 and the model management system 120 can provide the result to the user. In some embodiments, formatting of the result is done before it is provided to the user. For example, the result may be formatted into a chart, graph, or other visualization or converted into speech or audio output for the user.

Various embodiments provide an abstraction of machine learning and/or statistical models for the user where the user may submit a user statement requesting information from the model management system 120 without extensive knowledge of the many complex machine learning and statistical models available, which models are most appropriate for the user's query, and how to invoke the models. Users may simply communicate with the model management system 120, submit a query, and receive a result.

The network 110 can be any type of network and may include, for example, any one or more of a cellular network, a satellite network, a personal area network (PAN), a local area network (LAN), a wide area network (WAN), a broadband network (BBN), the Internet, and the like. Further, the network 110 can include, but is not limited to, any one or more of the following network topologies, including a bus network, a star network, a ring network, a mesh network, a star-bus network, tree or hierarchical network, and the like. Network 110 can be a public network, a private network, or a combination thereof. Communication network 110 may be implemented using any number of communications links associated with one or more service providers, including one or more wired communication links, one or more wireless communication links, or any combination thereof. Additionally, network 110 can be configured to support the transmission of data formatted using any number of protocols.

The one or more client devices 140 associated with the user 130 may include a number of components that enable the user 130 to communicate with the model management system 120. For example, a client device 140 may have one or more software modules configured to communicate with the model management system 120. The software modules may be provided by third-party vendors or by the model management system 120. The client device 140 may include one or more interfaces configured to receive various forms of input such as text, audio, or video input from the user and provide various forms of output for the user. For example, the one or more client devices 140 may include a computer, laptop, terminal, set top box, smart devices, or mobile device such as a smart phone. Although various embodiments envision the user 130 to be a person, in some embodiments, the user 130 may be a machine or third-party service configured to interact with the model management system 120 via an API.

Although various embodiments may be used in any of the many different fields in which machine learning or statistical modeling is used, many embodiments relate to the information technology (IT) field. For example, FIG. 1 includes one or more IT resources 150 configured to communicate with the model management systems 120, the one or more model providers 125, and/or client devices 140 via the network 110. Although FIG. 1 shows the IT resources 150 as a separate entity, in some embodiments, the IT resources 150 may be a part of the same platform as the model management system 120 and/or the model providers 125. IT resources 150 may include data sets for any other network or enterprise resources that may be monitored

The IT resources 150 may include a network policy system configured to enforce network policies, collect data about network security or the enforcement of network policies, and collect data about the performance of network entities (e.g., client device 140 or networking equipment). The data collected may include, for example, data for each network entity such as a number of policies being enforced by the network entity, a number of rules being enforced, a number of data packets being allowed, dropped, forwarded, redirected, or copied, or any other data related to the enforcement of network policies. The data collected may also related to network entity performance such as CPU usage, memory usage, a number of TCP connections, a number of failed connection, etc. The network policy system may receive the data from the network entities and store the collected data in inventory store and may serve as input data on which the machine learning and/or statistical models may operate.

The IT resources 150 may also include an application management system configured to manage and collect data about one or more applications hosted by one or more application servers in the network. In some embodiments, the application management system may host the application. The data collected may include, for example, data related to application performance, load, or other metrics associated with the running of an application. The application management system may receive the data and store the collected data in a data store and may serve as input data on which the machine learning and/or statistical models may operate.

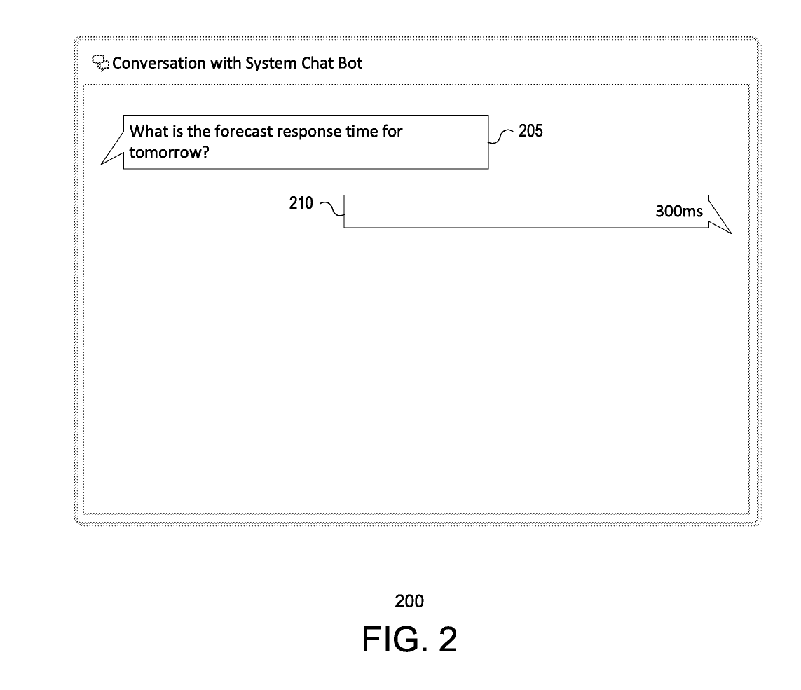

As described above, the model management system 120 may include an interface configured to enable communications with a user 130 via various communication channels. FIG. 2 is an example of one such communication channel. FIG. 2 is an illustration showing an example chat interface 200, in accordance with various embodiments of the subject technology. The chat interface 200 may be displayed on a client device and enabled by a software module (e.g., a chat application or web page on a web browser) running on the client device. The software module may be provided as a stand-alone module (e.g., a specialized instant messaging application) or a part of a larger suite of software modules (e.g., software for managing IT resources).

The chat interface 200 provides a way for the user to input a user statement 205 that can be transmitted to the model management system. The user statement 205 may be in the form of a natural language query (e.g., a question or statement requesting information). The model management system may receive the user statement and extract an intent type and one or more parameters from the user statement using a natural language engine. The intent type may represent a function that the user is requesting or that should be performed to satisfy the user's request. For example, based on the user statement 205 of “What is the forecast response time for tomorrow?” the model management system may identify “forecasting” as an intent type and two different parameters. One parameter being a metric type of “response time” and the other parameter being a time type of “tomorrow.” In some embodiments, the model management system may also identify an input dataset.

Based on the extracted information, the model management system selects an appropriate model, invokes the selected model to obtain a result, and provides the result to the user. The model management system may format the result such that it may be delivered to the user via the same communication channel that the user statement was received. For example, the result may be provided in a response 210 in the chat interface 200. Some results may also be formatted into visualization (e.g., diagrams, displays, charts, graphs, etc.) and provided to the user. These visualizations may be interactive and allow the user to dive deeper into the results, explore additional related information, or submit subsequent queries related to the results.

Although FIG. 2 illustrates a textual interface in the form of a chat interface, other types of textual interfaces (e.g., a search bar or other query field) may be used. Furthermore, additional channels of communications may also be used. For example, audio queries and results may be provided with speech-to-text technologies and text-to-speech technologies. Audio queries and results may be enabled by microphones and speakers on the client device or in communication with the client device. Audio results may be provided by themselves or in combination with textual results and/or visual results.

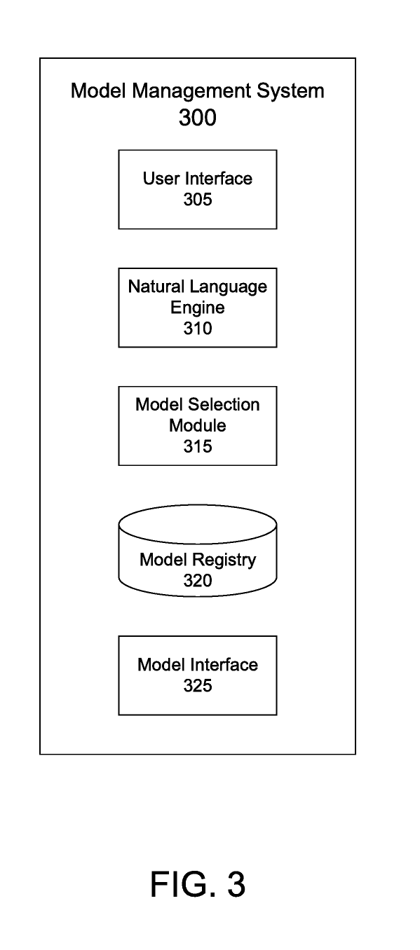

FIG. 3 is a conceptual block diagram illustrating an example of a model management system 300, in accordance with various embodiments of the subject technology. The model management system 300 is shown in FIG. 3 including a user interface 305, a natural language engine 310, a model selection module 315, a model registry 320, and a model interface 325. It should be understood that, in other embodiments, a model management system may include additional, fewer, or alternative components.

The user interface 305 is configured to communicate with a user via, for example, communications over a network to a client device. The user interface 305 may receive user statements or queries, provide results to the user, or redirect the user to additional resources. Once a user statement is received, the natural language engine 310 may process the user statement to extract and identify an intent type, one or more parameters, an input dataset, or other information that may be used to select an appropriate model and invoke the selected model. According to some embodiments, the natural language engine 310 may map certain keywords to data to be extracted (e.g., intent, parameters, expected output, or datasets). In some embodiments, a natural language processor that is a part of the natural language engine 310 or provided by a third-party may be used to identify the data to be extracted.

The model selection module 315 is configured to select an appropriate model based on the information extracted by the natural language engine 310. According to some embodiments, the model selection module 315 may select a model from all of the available models that have been registered with the model registry 320. The model registry 320 may be configured to register machine learning and other statistical models and store data associated with the models that may be compared with the extracted information from the user statement and/or used to select an appropriate model.

The model registry 320 may include information for each model such as one or more functions that each model offers (e.g., forecasting, regression, classification, anomaly detection, etc.), an application programming interface (API) that may be used to invoke the model, data and data format(s) that are expected by the model as inputs, data and data format(s) for an expected output, model performance information (e.g., an expected response time for a task, size of input data, accuracy of model from model testing, etc.), capacity and scalability of the model (e.g., the max throughput and data size the model can handle and/or how the performance scale), a cost of service, any underlying algorithms implemented (e.g., for a supervised classification model, the algorithms implementing the functions may include support vector machine, logistic regression, K-nearest neighbor, or deep learning neural networks), and/or information on the infrastructure hosting service providing the model (e.g., security, geo-graphical information that may be required for compliance purpose, etc.).

The information stored by the model registry 320 may be received from the model providers when a model is registered with the model management system 300 or in subsequent communications. In addition, the model registry 320 may also monitor the performance of each model and/or the model providers. The model registry 320 may track current performance data and record historical performance data for the models and the model providers. The performance data may include, for example, load, response time, or other benchmarks for the model or model providers.

The model selection module 315 may select an appropriate model based on the information extracted by the natural language engine 310 and the data associated with each available model stored in the model registry 320. According to some embodiments, the model selection module 315 may select models in the model registry 320 where the intent type extracted from the user statement matches the function of the model and the parameters extracted from the user statement are compatible with the data and data formats that the model takes as inputs. The model selection module 315 may also match the expected output extracted from the user statement with the data and data format for the expected output of the model and/or whether the input dataset extracted from the user statement is compatible with the datasets on which the model is configured to operate. Thus models that are not appropriate may be filtered out of consideration by the model selection module 315.

Additional models may further be eliminated from contention based on constraints or user preferences. For example, the model selection module 315 may access a user database that includes information about the user such as a user identifier, one or more roles or permissions, constraints, and user preferences. The user preferences can be specified by the user and may include, for example, models that the user does not wish to use. The constraints may be specified by an administrator and may be global (e.g., applying to the entire enterprise) or customized (e.g., based on the user's role or group affiliation). One example constraint may be a data sovereignty constraint that specifies that data cannot be transmitted out of a particular jurisdiction or into a specific set of jurisdictions. In such a scenario, those models that require data to be transmitted to another jurisdiction may be filtered out.

In some cases, more than one model in the model registry 320 may remain after eliminating the incompatible models. The model selection module 315 is configured to calculate a score for each compatible model so that a model may be selected. The score for a model may be calculated based on any of the data above as well as performance characteristics, scalability of the model, response time, model accuracy, or cost. The score may further be customized based on the input dataset and expected volume of data.

According to various embodiments, additional factors related to the performance of the model management system 300 may also be considered when selecting a model. For example, the model selection module 315 may approach the selection of the model as an optimization problem where an objective is to accommodate the maximum number of user request while satisfying the constraints specified by each request. When there is resource contention, the model selection module 315 may balance maximizing the number of user statements processed with maintaining some fairness among users.

According to some embodiments, the optimization problem may be formulated as a mixed linear/integer programming problem where the computing resources and selection of the optimum model for a user statement can be expressed as linear constraints. While doing so, the model selection module 315 takes into consideration the requests to be served (e.g., the number use statements to be processed), the current resource situation, but also the anticipated future requests and resource availability. The model selection module 315 may accomplish this by applying a machine-learning based forecasting model that can estimate the number of future user statements to that will be received and their mixes from training with historical data. Moreover, by monitoring the progress of the ongoing service of the model management system 300, the model selection module 315 can also predict the future resource availability.

The model interface 325 is configured to invoke the selected model, obtain a result from the invoked model, and to monitor the execution of the model in order to collect performance data on the model that can be stored by the model registry 320 and used to select models for subsequent requests. According to some embodiments, one or more of the models may be provided by the model managements system 300 and the model interface 325 may invoke these models directly. One or more models may also be provided by third-party model providers. These models may be called upon using an API specified by the model providers. When results are obtained by the model interface 325, the results may be processed or formatted for delivery and transmitted to the user via the user interface 305.

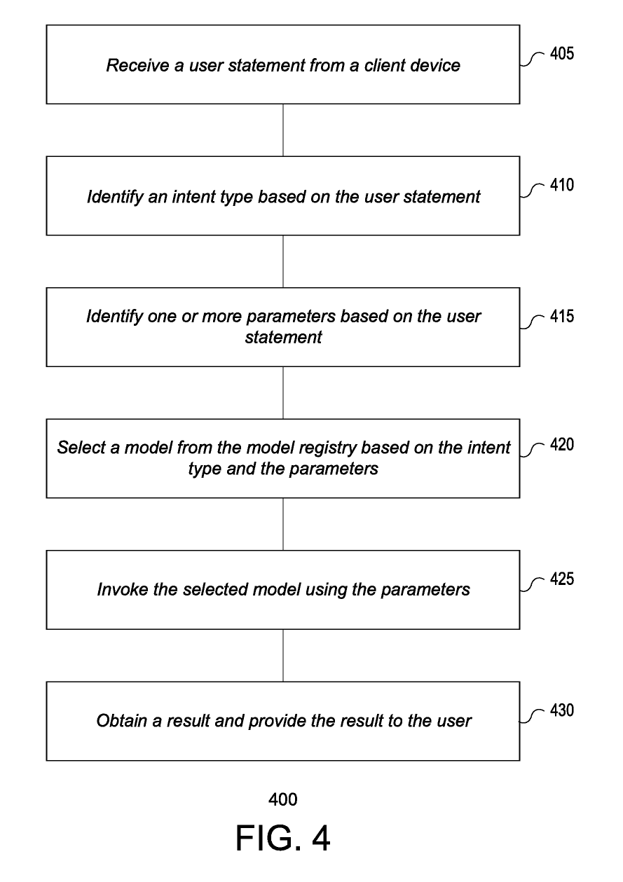

FIG. 4 shows an example process 400 for obtaining a result from a model management system, in accordance with various embodiments of the subject technology. It should be understood that, for any process discussed herein, there can be additional, fewer, or alternative steps performed in similar or alternative orders, or in parallel, within the scope of the various embodiments unless otherwise stated. The process 400 can be performed by a model management system or similar system.

At operation 405, the model management system receives a user statement requesting information from the model management system. According to various embodiments, the user statement may be received from a client device via a network, at a terminal in communication with the model management system, or from a user inputting a query into the model management system.

The user statement may be received in various form (e.g., textual, audio, etc.) and formatted before being processed by a natural language engine. The user statement may also be received through various channels. For example the user statement may be submitted on a website through a web browser running on a client device, an application supported by the model management system, or a third-party communication application running on the client device. Although the information requested by the user may relate to various fields, in the IT area, the user request may relate to the performance of a network, an application or application server, or other IT resources.

At operations 410 and 415, the model management system may identify an intent type and one or more parameters based on the user statement. The intent type may represents the function to be performed by a model and may include, for example, to predict, forecast, classify, correlate, recommend, identify trends, identify anomalies, identify sentiment, or identify associations. The parameters may include data that may be inputted into the models and used by the models to generate a result. The parameters may be categorized as metric types or time types. Metric type parameters may represent a desired output, an input, or other factors. Time type parameters may represent a past time period for analysis, a future time period for prediction or forecasting, or some other time frame to be used by the model.

The model management system may also determine at least one dataset on which to operate. The dataset may be identified based on the user statement, user information, or group information. For example, one or more datasets for analysis may be specified by the user in the user statement, or stored in a user record (e.g., a user profile) in a database, or in a group or enterprise record that specifies which datasets the user is able to access.

At operation 420, the model management system may select a model from the model registry based on the intent type and the one or more parameters. For example, they may access information about the available models from the model registry and filter the models based on the intent types and parameters extracted from the user statement and the functions, inputs, and outputs for each model as specified in the model registry. If models in the model registry are unable to perform the function specified by the intent type, are unable to take as inputs input parameters specified in the user statement, or unable to generate an outputted result compatible with output parameters specified in the user statement, the model may be removed from consideration.

The available models may further be filtered based on constraints and/or user preferences. For example, a user record may specify a preference for certain models or unpermitted models that are not to be used. Constraints found in a user record or group record may also specify certain characteristics that models must have or cannot have. Based on these user preferences or constraints, additional models may be removed from consideration.

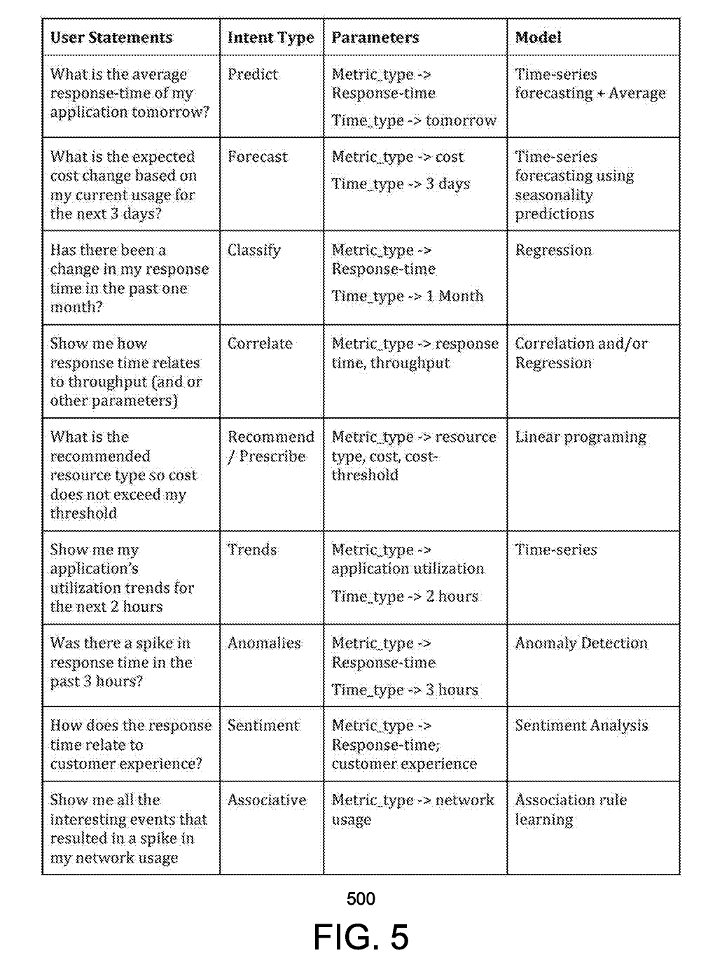

FIG. 5 is a chart 500 illustrating relationships between user statements, intent types, parameters, and models, in accordance with various aspects of the subject technology. The chart 500 helps illustrate how an intent type and parameters may be extracted from a user statement, as well as an example model that may be appropriate for invocation.

According to some embodiments, if only one model in the model registry is compatible with the user statement, the one model is selected for invocation. If no model in the model registry is compatible with the user statement, the model management system may notify the user and offer the best effort or closest model available or inform the user that the user statement cannot be satisfied. If not all parameters required to invoke a model or select a model may be extracted from the user statement, the model management system may request additional parameters from the user.

In some cases, however, multiple models may be compatible with the user statement. The model management system may calculate a score for each compatible model based on, for example, performance characteristics, scalability of the model, response time, model accuracy, or cost. Based on the scores, the model management system may select a model for invocation.

At operation 425, the model management system may invoke the selected model and initiate a process that uses the model to obtain a result. The model may be invoked via an API call using the parameters. The invoked model may return a result to the model management system and, once obtained, the model management system may provide the result to the user at operation 430. In some embodiments, before the result is provided to the user, the result may be formatted, summarized, visualized, supplemented, or otherwise processed.

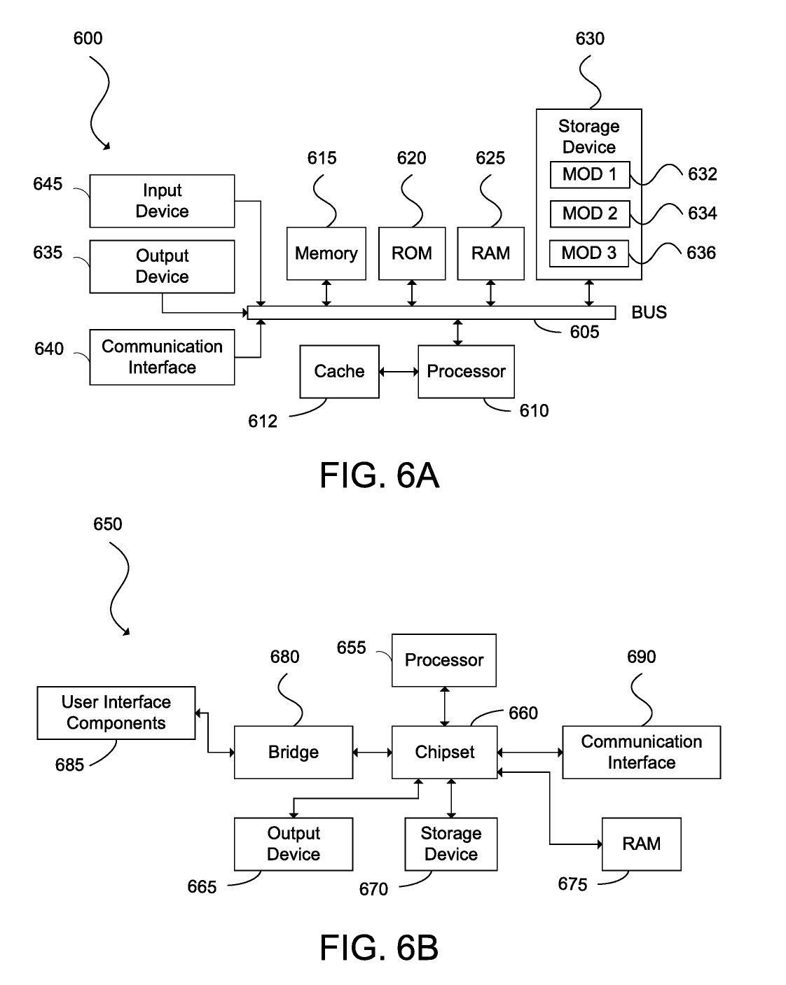

FIG. 6A and FIG. 6B illustrate systems in accordance with various embodiments. The more appropriate system will be apparent to those of ordinary skill in the art when practicing the various embodiments. Persons of ordinary skill in the art will also readily appreciate that other systems are possible.

FIG. 6A illustrates an example architecture for a conventional bus computing system 600 wherein the components of the system are in electrical communication with each other using a bus 605. The computing system 600 can include a processing unit (CPU or processor) 610 and a system bus 605 that may couple various system components including the system memory 615, such as read only memory (ROM) in a storage device 620 and random access memory (RAM) 625, to the processor 610. The computing system 600 can include a cache 612 of high-speed memory connected directly with, in close proximity to, or integrated as part of the processor 610. The computing system 600 can copy data from the memory 615 and/or the storage device 630 to the cache 612 for quick access by the processor 610. In this way, the cache 612 can provide a performance boost that avoids processor delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing system 600, an input device 645 can represent any number of input mechanisms, such as a microphone for speech, a touch-protected screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing system 600. The communications interface 640 can govern and manage the user input and system output. There may be no restriction on operating on any particular hardware arrangement and therefore the basic features here may easily be substituted for improved hardware or firmware arrangements as they are developed.

Storage device 630 can be a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, output device 635, and so forth, to carry out the function.

FIG. 6B illustrates an example architecture for a conventional chipset computing system 650 that can be used in accordance with an embodiment. The computing system 650 can include a processor 655, representative of any number of physically and/or logically distinct resources capable of executing software, firmware, and hardware configured to perform identified computations. The processor 655 can communicate with a chipset 660 that can control input to and output from the processor 655. In this example, the chipset 660 can output information to an output device 665, such as a display, and can read and write information to storage device 670, which can include magnetic media, and solid state media, for example. The chipset 660 can also read data from and write data to RAM 675. A bridge 680 for interfacing with a variety of user interface components 685 can be provided for interfacing with the chipset 660. The user interface components 685 can include a keyboard, a microphone, touch detection and processing circuitry, a pointing device, such as a mouse, and so on. Inputs to the computing system 650 can come from any of a variety of sources, machine generated and/or human generated.

The chipset 660 can also interface with one or more communication interfaces 690 that can have different physical interfaces. The communication interfaces 690 can include interfaces for wired and wireless LANs, for broadband wireless networks, as well as personal area networks. Some applications of the methods for generating, displaying, and using the GUI disclosed herein can include receiving ordered datasets over the physical interface or be generated by the machine itself by processor 655 analyzing data stored in the storage device 670 or the RAM 675. Further, the computing system 600 can receive inputs from a user via the user interface components 685 and execute appropriate functions, such as browsing functions by interpreting these inputs using the processor 655.

It will be appreciated that computing systems 600 and 650 can have more than one processor 610 and 655, respectively, or be part of a group or cluster of computing devices networked together to provide greater processing capability.

For clarity of explanation, in some instances the various embodiments may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method comprising:
receiving a user statement comprising a request for information;
identifying an intent type based on the user statement;
identifying one or more parameters based on the user statement;
selecting a machine learning model from a model registry based on the intent type and the one or more parameters; and
obtaining a result based on invoking the selected machine learning model using the one or more parameters.

2. The computer-implemented method of claim 1, wherein the request for information is regarding performance of an application server.

3. The computer-implemented method of claim 1, wherein the intent type is one of predict, forecast, classify, correlate, recommend, trends, anomalies, sentiment, associative.

4. The computer-implemented method of claim 1, wherein the parameters include at least one of a metric type or a time type.

5. The computer-implemented method of claim 1, further comprising determining at least one dataset on which to operate based on the user statement.

6. The computer-implemented method of claim 1, wherein the model registry contains machine learning modules provided by third-party providers.

7. The computer-implemented method of claim 1 wherein invoking the selected machine learning model comprises communicating with a machine learning service via an application program interface (API).

8. The computer-implemented method of claim 1, wherein selecting the machine learning model from the model registry comprises:
matching the intent type with a function of the machine learning model specified in the model registry; and
matching the one or more parameters with data formats for the machine learning model specified in the model registry.

9. The computer-implemented method of claim 1, further comprising:
identifying at least one compatible machine learning model based on the intent type and the one or more parameters;
calculating a score for each of the at least one compatible machine learning model based on at least performance data or cost data for the at least one compatible machine learning model specified in the model registry; and
wherein the selecting of the machine learning model from the model registry is based on the score for the machine learning model.

10. The computer-implemented method of claim 1, further comprising:
providing the result to a user;
generating performance data by monitoring performance of the selected machine learning model; and
storing the performance data in a record for the selected machine learning model, wherein the record is stored in the model registry.

11. A non-transitory computer-readable medium comprising instructions, the instructions, when executed by a computing system, cause the computing system to perform operations comprising:
receiving a user statement comprising a request for information;
identifying an intent type and one or more parameters based on the user statement;
selecting a model from a model registry based on the intent type and the one or more parameters; and
obtaining a result based on invoking the selected model using the one or more parameters.

12. The non-transitory computer-readable medium of claim 11, wherein the model is a machine learning model.

13. The non-transitory computer-readable medium of claim 11, further comprising determining at least one dataset on which to operate based on the user statement, wherein the selecting of the model from the model registry is further based on the at least one dataset.

14. The non-transitory computer-readable medium of claim 11, wherein selecting the model from the model registry comprises:
matching the intent type with a function of the model specified in the model registry; and
matching the one or more parameters with data formats for the model specified in the model registry.

15. The non-transitory computer-readable medium of claim 11, wherein the operations further comprise:
identifying at least one compatible model based on the intent type and the one or more parameters;
calculating a score for each of the at least one compatible model based on at least performance data or cost data for the at least one compatible model specified in the model registry; and
wherein the selecting of the model from the model registry is based on the score for the model.

16. The non-transitory computer-readable medium of claim 11, wherein the operations further comprise:
generating performance data by monitoring performance of the selected model; and
storing the performance data in a record for the selected model, wherein the record is stored in the model registry.

17. A system comprising:
a processor; and
a non-transitory computer-readable medium storing instructions that, when executed by the system, cause the system to:
receive a user query for machine learning services;
identify an intent type and one or more parameters based on the user query;
select a machine learning model from a model registry based on the intent type and the one or more parameters; and
obtain a result based on invoking the selected machine learning model using the one or more parameters.

18. The system of claim 17, wherein the instructions further cause the system to:
match the intent type with a function of the machine learning model specified in the model registry; and
match the one or more parameters with data formats for the machine learning model specified in the model registry.

19. The system of claim 17, wherein the instructions further cause the system to:
identify at least one compatible machine learning model based on the intent type and the one or more parameters;
calculate a score for each of the at least one compatible machine learning model based on at least performance data or cost data for the at least one compatible machine learning model specified in the model registry; and
wherein the machine learning model is selected from the model registry based on the score for the machine learning model.

20. The system of claim 17, wherein the instructions further cause the system to:
generate performance data by monitoring performance of the selected machine learning model; and
store the performance data in a record for the selected machine learning model, wherein the record is stored in the model registry.
